(19) United States
(12) Patent Application Publication
(10) Pub. No.: US 2012/0315570 A1
(43) Pub. Date: Dec. 13, 2012

(54) COLLECTOR FOR FUEL CELL AND FUEL CELL USING THE SAME

(75) Inventors: Sun-Dong KIM, Daejeon (KR); Doo-Won SEO, Daejeon (KR); In-Sub HAN, Geumsan-gun (KR); Se-Young KIM, Seongnam-si (KR); Ji-Haeng YU, Daejeon (KR); Sang-Kuk WOO, Daejeon (KR)

(73) Assignee: KOREA INSTITUTE OF ENERGY RESEARCH, Daejeon (KR)

(21) Appl. No.: 13/370,658

(22) Filed: Feb. 10, 2012

(30) Foreign Application Priority Data
Jun. 10, 2011 (KR) 10-2011-0056195

(51) Int. Cl. H01M 4/86

(52) U.S. Cl. 429/521

(57) ABSTRACT

A collector for a fuel cell and a fuel cell are provided. The collector for a fuel cell comprises a conductive material and silicon carbide, wherein the conductive material is disposed in the silicon carbide. The collector for a fuel cell according to the present invention has excellent electrical conductivity both at a high temperature of 850° C. or more and at room temperature because it includes a conductive material and silicon carbide.

### CROSS REFERENCE TO RELATED APPLICATION

This application claims the benefit of Korean Patent Application No. KR 10-2011-0056195, filed Jun. 10, 2011, which is hereby incorporated by reference in its entirety into this application.

### BACKGROUND OF THE INVENTION

1. Technical Field

The present invention relates to a collector for a fuel cell and a fuel cell using the same.

2. Description of the Related Art

Solid oxide fuel cells (SOFCs) operate at a high temperature of 600˜1000° C., and can use various hydrocarbon materials, such as natural gas and the like, as raw materials. When a solid oxide fuel cell is a mixed-type solid fuel cell connected with a gas turbine, it has very high efficiency at high temperature, and barely discharges any environmental pollutants. Therefore, solid oxide fuel cells are attracting considerable attention as a next-generation clean energy source.

Meanwhile, a metal collector is used in order to collect the electricity generated from a fuel cell. Examples of metal collectors include a SUS400-based collector, a Crofer-based collector, an Inconel-based collector, a precious metal (platinum, gold, silver or the like)-based collector and the like. Concretely, a SUS400-based collector or an Inconel-based collector is used at 700° C. or less, and a Crofer-based collector coated with an antioxidant film is used at 700-800° C. depending on the range of operating temperatures of a fuel cell.

However, since the metal collector is corroded and poisoned with chromium (Cr) at high temperature, it is difficult to increase the operation temperature thereof. Particularly, when the SUS400-based collector or the Crofer-based collector is operated at high temperature for a long period of time, the surface thereof becomes oxidized and an oxide film forms, so that the ohmic resistance of the entire cell increases, thereby deteriorating electrical conductivity. Further, the SUS400-based collector or the Crofer-based collector is problematic in that the performance of a fuel cell is deteriorated due to a volatilized and diffused chromium (Cr) component.

Precious metal-based collectors are used in the form of a precious metal mesh or wire to conduct fuel cell tests on the laboratory scale, but it is difficult to produce them in large quantities due to economical problems.

On the other hand, silicon carbide (SiC)-based materials are materials that can be used as a structural material at high temperature, that do not corrode in a high-temperature oxidation atmosphere, and that do not easily react with other materials. Further, the resistance of the silicon carbide-based material becomes low depending on the increase in temperature, thus improving the electrical conductivity thereof. Therefore, the silicon carbide-based material can be used as a material for a collector of a fuel cell at high temperature.

However, since the electrical conductivity of the silicon carbide-based material is very low at room temperature, a collector made of the silicon carbide-based material cannot be used as a collector integrated with the externals of a fuel cell system at room temperature. In order to overcome such a problem, a collector can be connected with a metallic bus bar and then used, but the metallic bus bar easily corrodes, which makes it difficult to use.

[Prior Art Documents]

[Patent Documents]

Japanese Unexamined Patent Publication No. 09-129250

Korean Unexamined Patent Publication No. 10-2005-0019083

Japanese Unexamined Patent Publication No. 2005-19058

### SUMMARY OF THE INVENTION

Accordingly, the present invention has been devised to solve the above-mentioned problems, and an object of the present invention is to provide a collector for a fuel cell, which has high electrical conductivity both at a high temperature of 850° C. or more and at room temperature and which does not corrode.

Another object of the present invention is to provide a collector for a fuel cell, which can improve the operating efficiency of the fuel cell and which can minimize the deterioration in performance of the fuel cell attributable to volatilized chromium (Cr) or the like, and a fuel cell using the same.

Still another object of the present invention is to provide a collector for a fuel cell, which has a low manufacturing cost and a light weight, and a fuel cell using the same.

Still another object of the present invention is to provide a collector for a fuel cell, the electricity collecting efficiency of which is not decreased even when it is used for a long period of time, the life cycle of which is long and the durability of which is excellent, and a fuel cell using the same.

In order to accomplish the above objects, an aspect of the present invention provides a collector for a fuel cell, including: a conductive material; and silicon carbide, wherein the conductive material is disposed in the silicon carbide.

Another aspect of the present invention provides a fuel cell including the collector.

### BRIEF DESCRIPTION OF THE DRAWINGS

The above and other objects, features and further advantages of the present invention will be more clearly understood from the following detailed description taken in conjunction with the accompanying drawings, in which:

FIG. 1 is a schematic section view showing a collector for a fuel cell according to the present invention;

FIG. 2 is a view showing a collector for a fuel cell, which has a core-shell structure of a conductive material and silicon carbide, according to an embodiment of the present invention;

FIG. 3 is a view showing a collector for a fuel cell, which has a core-shell structure of a conductive material and silicon carbide, according to another embodiment of the present invention; and

FIG. 4 is a view showing a collector for a fuel cell according to still another embodiment of the present invention.

### DESCRIPTION OF THE PREFERRED EMBODIMENTS

Hereinafter, preferred embodiments of the present invention will be described in detail with reference to the attached drawings.

In the present invention, a collector for a fuel cell is a plate for separating unit cells in a fuel cell, a connector disposed between unit cells in a fuel cell, or a stack for collecting electricity in a fuel cell.

The present invention provides a collector for a fuel cell, including: a conductive material; and silicon carbide, wherein the conductive material is disposed in the silicon carbide. That is, in the collector, it is preferred that the surface of the conductive material be entirely protected by the silicon carbide.

The collector for a fuel cell has excellent electrical conductivity both at a high temperature of 850° C. or more and at room temperature because it includes a conductive material and silicon carbide, unlike a silicon carbide-based collector which has excellent electrical conductivity only at a high temperature of 850° C. or more and through which electricity does not flow at room temperature. Further, the collector for a fuel cell corrodes neither at a high temperature of 850° C. or more nor at room temperature because it includes a conductive material and silicon carbide, unlike a metal collector which corrodes at a high temperature of 850° C. or more. Further, the collector for a fuel cell is manufactured at low cost and is light because it includes silicon carbide, unlike a metal collector which includes only a metal.

Here, since the conductive material is disposed in silicon carbide, that is, the surface of the conductive material is entirely protected by silicon carbide, the conductive material is not exposed to the outside, so that the surface of the conductive material is not oxidized, with the result that the loss of electric current due to resistance is minimized, thereby improving electrical conductivity.

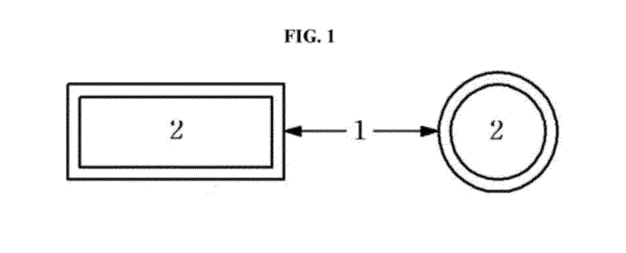

FIG. 1 is a schematic section view showing a collector for a fuel cell according to the present invention.

As shown in FIG. 1, the collector for a fuel cell includes a conductive material and silicon carbide, wherein the conductive material may be disposed in silicon carbide such that the conductive material is protected by the silicon carbide.

The structure of the collector for a fuel cell, as described above, is not particularly limited as long as the conductive material is not exposed to the outside. However, the collector for a fuel cell may have a core-shell structure in which the conductive material is enveloped with the silicon carbide, a structure in which the silicon carbide and the conductive material are laminated or a structure in which the conductive material permeates into the silicon carbide. Here, the structure in which the silicon carbide and the conductive material are laminated may be a structure in which the silicon carbides are applied onto both side of the conductive material to allow the silicon carbides to protect the conductive material.

Meanwhile, the conductive materials may be connected with each other such that electric current is transferred from the inside of the collector to the outside thereof at room temperature.

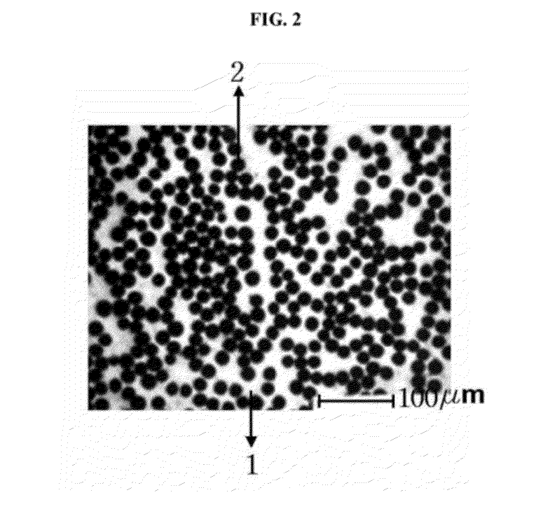

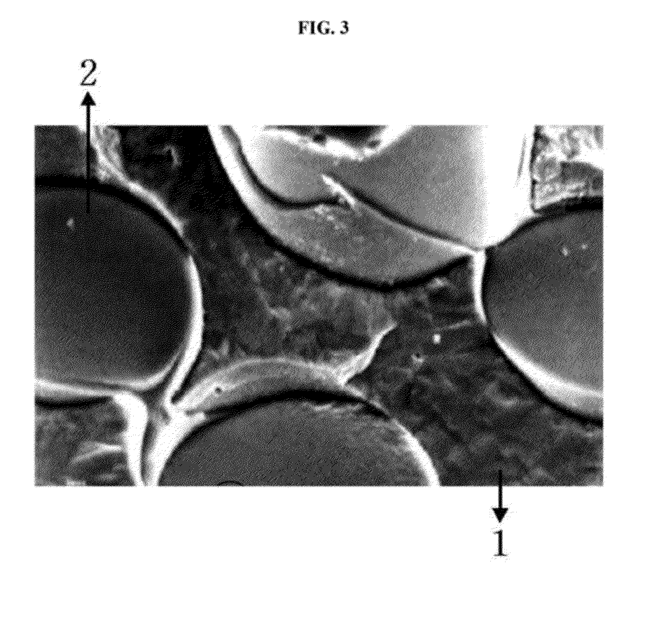

FIG. 2 is a view showing a collector for a fuel cell, which has a core-shell structure of a conductive material and silicon carbide, according to an embodiment of the present invention. FIG. 3 is a view showing a collector for a fuel cell, which has a core-shell structure of a conductive material and silicon carbide, according to another embodiment of the present invention. As shown in FIGS. 2 and 3, it can be seen that each of the collectors has a structure in which a conductive material is enveloped with silicon carbide.

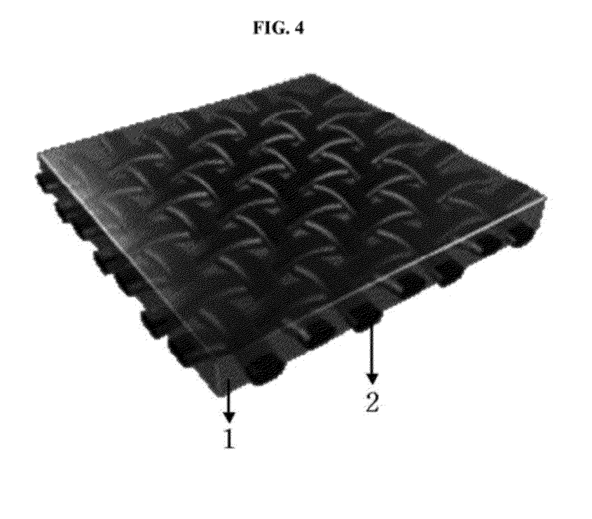

FIG. 4 is a view showing a collector for a fuel cell according to still another embodiment of the present invention. As shown in FIG. 4, it can be seen that the collector is configured such that a conductive material is woven in the form of fabric and is entirely enveloped with silicon carbide.

The conductive material is not particularly limited as long as it can be used in the related field. Preferably, the conductive material may include at least one selected from the group consisting of copper (Cu), nickel (Ni), gold (Au), platinum (Pt), palladium (Pd), ruthenium (Ru), iridium (Ir), silicon (Si) and carbon (C). The form of the conductive material is not particularly limited as long as it does not influence the electrical conductivity. Preferably, the conductive material may assume the form of particles or fibers.

In the collector for a fuel cell, the weight ratio of the conductive material to the silicon carbide may be 1:9˜9:1, preferably 4:6˜6:4. When the weight ratio of the conductive material to the silicon carbide satisfies 1:9˜9:1, the collector for a fuel cell corrodes neither in a high-temperature oxidative atmosphere nor at room temperature in a normal atmosphere, and has excellent electrical conductivity.

The present invention provides a fuel cell including the collector which includes the conductive material and the silicon carbide. The fuel cell may be a solid oxide fuel cell, but is not limited thereto.

The fuel cell including the collector according to the present invention can improve operating efficiency, can be manufactured at low cost, and is light. Further, the fuel cell has a long life cycle and high durability because its electricity collecting efficiency does not drop even when it is used for a long period of time.

Hereinafter, the present invention will be described in more detail with reference to the following Examples. However, these Examples are set forth to illustrate the present invention, and the scope of the present invention is not limited thereto. These Examples may be appropriately modified and changed by those skilled in the art within the scope of the present invention.

### EXAMPLE 1 AND COMPARATIVE EXAMPLE 1

### Manufacturing of a Collector for a Fuel Cell

A carbon fiber charged with a cured phenol resin was carbonized at 900° C. to form a porous carbon complex. The porous carbon complex was coated with silicon, and was then heat-treated at 1620° C. . As a result, a part of the silicon reacted with the carbon fiber to form silicon carbide, another part of the silicon directly permeated into silicon carbide, and a part of the carbon fiber was left in a state of having not reacted with the silicon, thus forming a silicon carbide complex whose surface is made of silicon carbide and whose inside is charged with silicon and carbon fiber,

The silicon carbide complex of Example 1 includes silicon carbide, silicon and carbon fiber at composition ratios shown in Table 1 below. Thereafter, the silicon carbide complex of Example 1 was used as a collector for a fuel cell.

In Comparative Example 1, a collector for a fuel cell made of only silicon carbide was used as shown in Table 1 below.

TABLE 1

Conductive material

| | Silicon | Silicon | Carbon |
|---|---|---|---|
| | carbide (vol %) | (vol %) | fiber (vol %) |
| Example 1 | 30 | 30 | 40 |
| Comparative | 100 | — | — |
| Example 1 | | | |

<Test Example: Evaluation of Characteristics of Collectors for a Fuel Cell>

The resistances of the collectors for a fuel cell of Example 1 and Comparative Example 1 were measured at room temperature using a digital multimeter (manufactured by Fluke Corp., model name: 233). The results thereof are shown in Table 2 below.

TABLE 2

| | Resistance |
|---|---|
| Example 1 | 1.1 Ω |
| Comparative Example 1 | electricity did not flow |

As shown in Table 2 above, the resistance of the collector for a fuel cell of Example 1 according to the present invention was 1.1Ω at room temperature. Therefore, it can be seen that this collector for a fuel cell has excellent electrical conductivity.

In contrast, in the case of the collector for a fuel cell of Comparative Example 1 which was made of only silicon carbide, electricity did not flow at room temperature. Therefore, it can be seen that this collector for a fuel cell cannot be used at room temperature.

As described above, the collector for a fuel cell according to the present invention has excellent electrical conductivity both at a high temperature of 850° C. or more and at room temperature because it includes a conductive material and silicon carbide, unlike a silicon carbide-based collector which has excellent electrical conductivity only at a high temperature of 850° C. or more and through which electricity does not flow at room temperature. Further, the collector for a fuel cell corrodes neither at a high temperature of 850° C. or more nor at room temperature because it includes a conductive material and silicon carbide, unlike a metal collector which corrodes at a high temperature of 850° C. or more.

Further, the collector for a fuel cell according to the present invention can improve the operating efficiency of a fuel cell, and the fuel cell including this collector can be manufactured at low cost and is light. Further, according to the collector for a fuel cell of the present invention, the electricity collecting efficiency thereof is not decreased even when it is used for a long period of time, the life cycle thereof is long and the durability thereof is excellent.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A collector for a fuel cell, comprising: a conductive material; and silicon carbide, wherein the conductive material is disposed in the silicon carbide.

2. The collector for a fuel cell according to claim 1, wherein the collector has a core-shell structure in which the conductive material is enveloped with the silicon carbide.

3. The collector for a fuel cell according to claim 1, wherein the collector has a structure in which the silicon carbide is applied onto both sides of the conductive material.

4. The collector for a fuel cell according to claim 1, wherein the collector has a structure in which the conductive material permeates into the silicon carbide.

5. The collector for a fuel cell according to claim 1, wherein the conductive material includes at least one selected from the group consisting of copper (Cu), nickel (Ni), gold (Au), platinum (Pt), palladium (Pd), ruthenium (Ru), iridium (Ir), silicon (Si) and carbon (C).

6. The collector for a fuel cell according to claim 1, wherein a weight ratio of the conductive material to the silicon carbide is 1:9˜9:1.

7. A fuel cell, comprising the collector of claim 1.
